(19) United States
(12) Patent Application Publication
(10) Pub. No.: US 2007/0276852 A1
(43) Pub. Date: Nov. 29, 2007

(54) DOWNLOADING PORTIONS OF MEDIA FILES

(75) Inventor: Joseph T. Fletcher, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/420,296

(22) Filed: May 25, 2006

(51) Int. Cl. G06F 17/00

(52) U.S. Cl. 707/101

(57) ABSTRACT

A facility is described for downloading portions of media files. In various embodiments, the facility displays a timeline on a client computing device that is indicative of a duration of the media file that is stored on a server computing device. The facility receives from a user an indication of portions of the media file that are to be downloaded and downloads to the client computing device the indicated portions of the media file but not the other portions of the media file.

### BACKGROUND

Users of computer systems employ various software programs to render media files, including multimedia files. A media file is a digital file that contains digitized information, such as text, audio, video, images, and so forth. A multimedia file is a digital file that contains multiple media forms. A common example is a video file that contains a correlated sequence of images and audio, such as a movie. Rendering is the process of converting information from digital to analog form so that a person can perceive the information, such as by displaying text, playing back audio or video, drawing an image, and so forth.

Another example of a multimedia file is a collaboration file that is created, manipulated, or stored by collaboration software. Collaboration software is software that enables multiple users to share an application, view an online presentation or other document, or collaborate in other ways using computing devices engaged in a collaboration session. When an application is shared with multiple users, the users can each control the shared application, such as to edit a document. A collaboration session enables participants to share information or applications via their computing devices. The collaboration software can record the collaboration session in a multimedia file, which can contain audio, video, images, presentation graphics, mouse cursor movements, keyboard input, text, documents, and other facets of the collaboration.

Media files can become quite large because users may collaborate during a collaboration session that lasts for several hours. The collaboration session may also span multiple sessions so that, for example, a collaboration file has information from multiple collaboration sessions that, together, last for hours, which makes the media files even larger. Multimedia files can also be quite large. These large files can take a long time to download.

Users sometimes desire to view portions of media files. As an example, a user may desire to view a portion of a training video containing information pertaining to the user's task at hand rather than the entire training video. As another example, a user may desire to view a portion of a collaboration file during which the collaboration involved a topic of particular interest to the user. However, downloading the entire collaboration or media file can take a long time.

### SUMMARY

A facility is provided for identifying and downloading portions of a media file that is hosted by a server. The media file may be very large. The facility receives information from a user that identifies one or more portions of a media file, prepares a downloadable media file containing the identified portion or portions of the media file but not the other portions of the media file, and provides the prepared media file for downloading. The user can identify portions of the media file by selecting portions of it on a timeline representing the media file or by searching for annotations or other searchable information associated with the media file. The server may then create a downloadable media file containing the selected portions of the media file but not the other portions. Thus, the user can download just portions of the media file that the user may find to be relevant.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a block diagram illustrating an example of a suitable computing environment in which the facility may operate.

FIG. 1B is a block diagram illustrating a storage device of FIG. 1A in further detail.

FIG. 2 is a block diagram illustrating an example of a suitable environment in which the facility may operate in some embodiments.

FIGS. 3A-8 are display diagrams illustrating aspects of user interfaces associated with the facility in various embodiments.

FIG. 9 is a table diagram illustrating an annotations table in various embodiments.

FIG. 10 is a flow diagram illustrating a create_downloadable_content routine invoked by the facility in some embodiments.

FIG. 11 is a block diagram illustrating an example comparing original content and content that has been prepared for downloading.

### DETAILED DESCRIPTION

A facility is provided for identifying and downloading portions of a media file. Examples of media files include audio files, video files, multimedia files, and collaboration files. The media files may be hosted by a server either in a downloadable format or in a streaming format. In various embodiments, the facility receives information from a user that identifies one or more portions of a media file, prepares a downloadable media file containing the identified portion or portions of the media file but not the other portions of the media file, and provides the prepared media file for downloading. The user can identify portions of the media file by selecting a segment of a timeline representing the media file, by searching for annotations or other searchable information associated with the media file, and so forth. As an example, a user can indicate that content within a media file associated with a particular search term is to be downloaded. The facility then creates downloadable content by retrieving from the media file the identified portions and assembling the retrieved portions into a downloadable media file. The facility can then download the downloadable content to the user's computer. The user can then cause the computer to render the downloaded content without having to download the entire media file.

In various embodiments, the facility may identify and retrieve portions of the media file that are associated with search terms the user provides. As an example, the facility may search for the search terms in annotations associated with the media file. Annotating media files is described in further detail in U.S. patent application Ser. No. 11/383,346, filed on May 15, 2006, and entitled “Annotating Media Files,” the disclosure of which is incorporated herein by reference in its entirety. As another example, the facility may search for the search terms in information associated with the media file, such as in a collaboration file. Collaboration files can contain information corresponding to a presentation, text typed by a viewer of the presentation, and so forth.

Thus, the facility can identify and provide a portion of a media file based on selection information provided by a user.

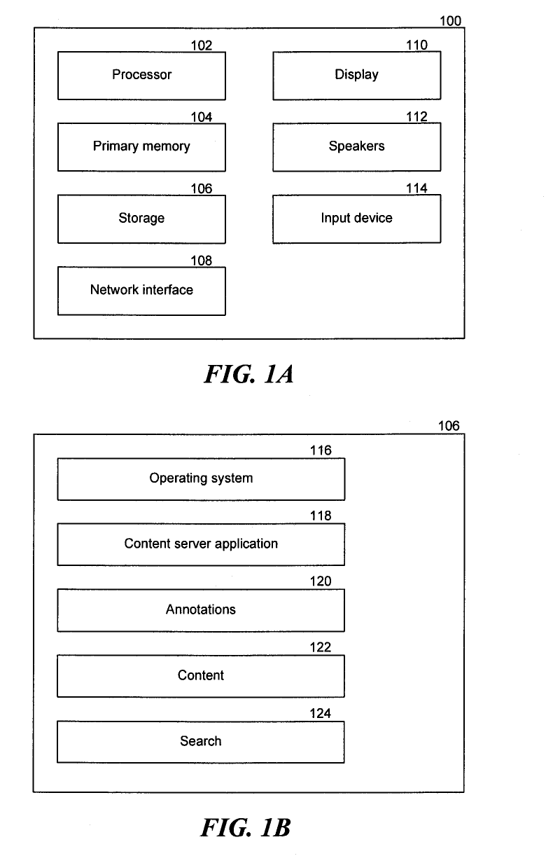

Turning now to the figures, FIG. 1A is a block diagram illustrating an example of a suitable computing environment 100 in which the facility may be implemented. A system for implementing the facility includes a general purpose computing device in the form of the computing system 100 (“computer”). Components of the computer may include, but are not limited to, a processing unit 102, a system primary memory 104, a storage device 106, a network adapter or interface 108, a display 110, one or more speakers 112, and an input device 114.

The computer 100 typically includes a variety of computer-readable media that are operable with the storage device 106. Computer-readable media can be any available media that can be accessed by the computer 100 and include both volatile and nonvolatile media and removable and nonremovable media.

The computer 100 may operate in a networked environment using logical connections to one or more remote computers. A remote computer may be a personal computer, a server, a router, a network PC, a peer device, or other common network node, and typically includes many or all of the elements described above in relation to the computer 100. A logical connection can be made via a local area network (LAN) or a wide area network (WAN), but may also include other networks. Such networking environments are commonplace in homes, offices, enterprise-wide computer networks, intranets, and the Internet. The computer 100 can be connected to a network through a network interface or adapter 108, such as to a wired or wireless network.

The computer 100 is only one example of a suitable computing environment and is not intended to suggest any limitation as to the scope of use or functionality of the facility. Neither should the computing system be interpreted as having any dependency or requirement relating to any one or a combination of the illustrated components.

The facility is operational with numerous other general purpose or special purpose computing systems or configurations. Examples of well-known computing systems, environments, and/or configurations that may be suitable for use with the facility include, but are not limited to, personal computers, server computers, handheld or laptop devices, cellular telephones, tablet devices, multiprocessor systems, microprocessor-based systems, set-top boxes, programmable consumer electronics, network PCs, minicomputers, mainframe computers, distributed computing environments that include any of the above systems or devices, and the like.

The facility may be described in the general context of computer-executable instructions, such as program modules, that are executed by a computer. Generally, program modules include routines, programs, objects, components, data structures, and so forth that perform particular tasks or implement particular abstract data types. The facility may also be employed in distributed computing environments where tasks are performed by remote processing devices that are linked through a communications network. In a distributed computing environment, program modules may be located in local and/or remote computer storage media, including memory storage devices.

FIG. 1B is a block diagram illustrating a storage device of FIG. 1A in further detail. According to the illustrated embodiment, the storage device 106 stores an operating system 116, a content server application 118, annotations 120, and content 122. The content server application is an application that provides content for downloading. The annotations are information, e.g., “metadata,” that is associated with content and can be stored in files, in a registry, or in any location from which the content server application program can retrieve data. The annotations can also be stored with the content. Content is data that is provided to a client application for rendering. The content is provided in media files, such as audio files, video files, collaboration files, and so forth. The storage device may also store other application programs and data (not illustrated). The facility can additionally have a search component 124 that searches for annotations matching a criterion (or multiple criteria) provided by the user. The criterion or criteria can include search terms that the search component seeks in annotations or searchable content associated with a media file (e.g., text in a collaboration file).

While various functionalities and data are shown in FIGS. 1A and 1B as residing on particular computer systems that are arranged in a particular way, those skilled in the art will appreciate that such functionalities and data may be distributed in various other ways across computer systems in different arrangements. While computer systems configured as described above are typically used to support the operation of the facility, one of ordinary skill in the art will appreciate that the facility may be implemented using devices of various types and configurations, and having various components.

The techniques may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

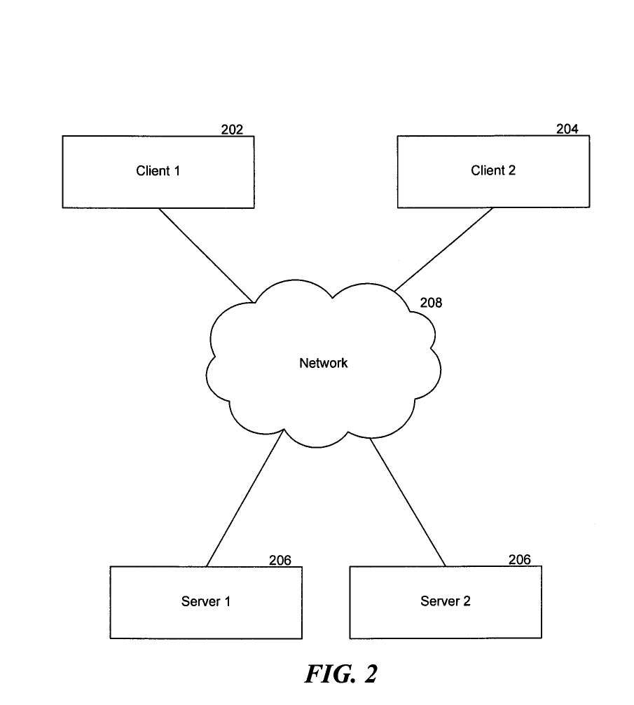

FIG. 2 is a block diagram illustrating an example of a suitable environment in which the facility may operate in some embodiments. The illustrated environment has two client computers 202 and 204, though can have additional client computers. The client computers may be interconnected to one or more server computers 206 via a network 208. The network 208 can be an intranet, the Internet, or a combination of multiple networks. In various embodiments, the environment may have additional client or server computers.

In various embodiments, the client or server computing devices may be a host computing device. A host computing device is a computing device that participates in a collaboration session by hosting the collaboration. The host computing device may also store media files, such as collaboration files.

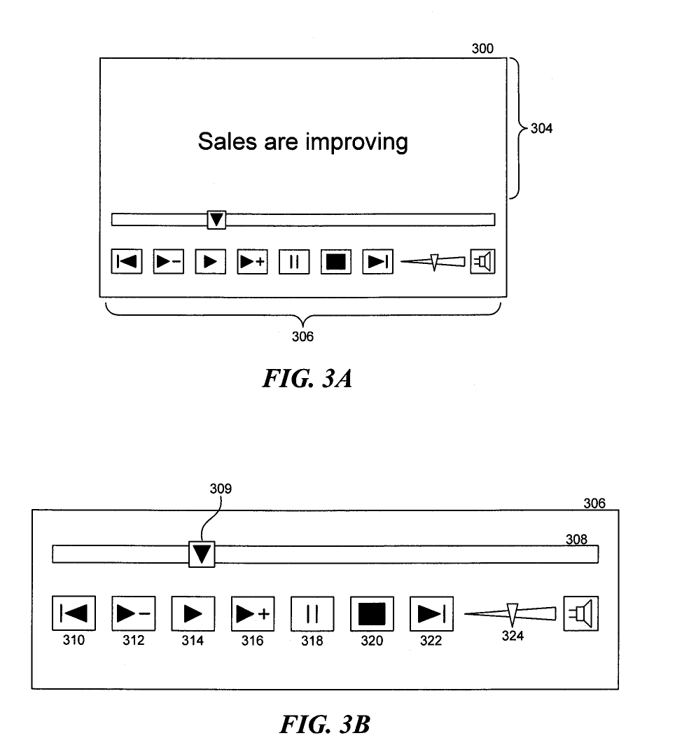

FIGS. 3A-8 are display diagrams illustrating aspects of user interfaces associated with the facility in various embodiments.

FIG. 3A is a display diagram illustrating a portion of a user interface 300 of a content rendering application, such as a collaboration application. The content is rendered in a presentation region 304. A user can manipulate the rendering of recorded content, such as a recorded collaboration session, by using the playback controls illustrated in a playback controls region 306. The playback controls are described in further detail below in relation to FIG. 3B. The playback controls region may be hidden, such as when a user is actively engaged in a collaboration session.

FIG. 3B is a display diagram illustrating the playback controls region 306 in further detail. The playback controls region can have multiple elements (e.g., “controls”) that enable a user to control the rendering of a media file, such as a collaboration file.

A timeline 308 indicates a duration of the media file. In some embodiments, the actual duration (e.g., in hours, minutes, and seconds) may additionally be provided (not illustrated). The timeline can be illustrated before a media file is downloaded. As an example, a pointer 309 indicates a position at which the facility is rendering content from the media file, in relation to the duration of the media file. When the pointer is at the leftmost position of the timeline, the beginning of the media file is indicated.

Controls 310-324 enable the user to control the rendering of the media file. When a user selects control 310, the facility moves the pointer to the leftmost position of the timeline. When the user selects control 322, the facility moves the pointer to the rightmost position of the timeline (e.g., the end of the media file).

Controls 312, 314, and 316 enable the user to select a rendering speed. Control 312 enables a user to decrease the rendering speed. Control 314 enables the user to set the rendering speed at a normal speed (e.g., a speed at which the media file was originally recorded or at which the rendering time corresponds to “real” time). Control 316 enables the user to increase the rendering speed. Control 318 enables the user to pause rendering and control 320 enables the user to stop rendering. Control 324 enables the user to increase or decrease the volume of any audio that is played in the speakers.

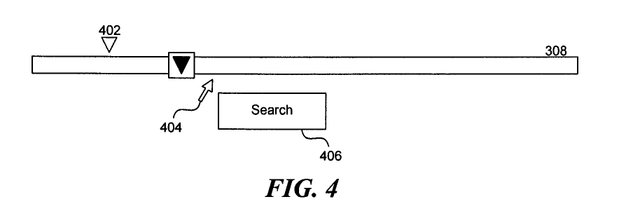

FIG. 4 is a display diagram illustrating the timeline 308 in further detail. An indication 402 (e.g., a marker) indicates a point or region (e.g., portion) of a media file that will be downloaded. The user can identify additional regions by positioning a mouse pointer 404 near the timeline and selecting a Search command 406 from a context menu. In various embodiments, the user can identify additional portions of the media file for downloading, such as by using a keyboard or menu of an application, selecting portions of the timeline using a mouse pointer, and so forth.

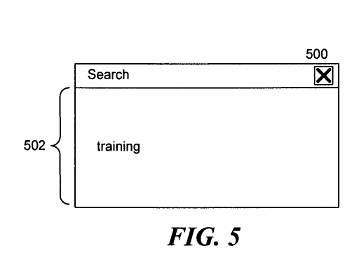

FIG. 5 illustrates a search user interface 500. The facility displays the search user interface when the user selects the search command from the search menu. A user can enter search terms in a region 502 of the search user interface and initiate the search by selecting a command (not shown). The facility then determines whether the search term appears in annotations or other metadata associated with the media file or in the content itself.

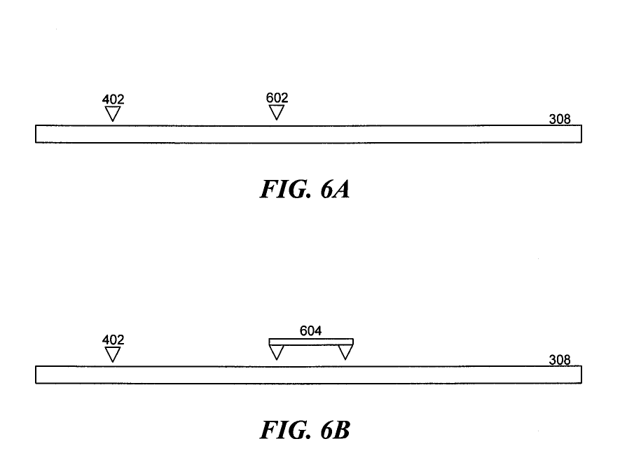

FIG. 6A is a display diagram illustrating the timeline with an additional indication or marker 602 corresponding to a position at which the facility located the search term. Alternatively, the marker can indicate a position or range selected by the user manually, such as by using a mouse pointer.

FIG. 6B is a display diagram illustrating the timeline with an additional indication or marker region 604 corresponding to the region (e.g., portion of the media file) or time span at which the search term was located in the media file. A user may also be able to indicate a time span, e.g., by dragging a mouse pointer.

In various embodiments, a user can select a subset of a set of portions the facility identifies in response to a search request. As an example, upon receiving a search term, the facility may identify several portions of the media file corresponding to the search term, such as by adding several markers to the timeline. The user may then be able to select zero, one, multiple, or all of the identified portions of the media file for downloading. The user can identify which portions to download by removing some of the markers on the timeline or adding markers. Alternatively, the facility may provide a list of portions and the user can identify which regions from the list to download.

In various embodiments, the facility downloads additional portions of the media file, such as portions just before or after the portions identified by the search, so that additional context can be provided to the user. As an example, the facility may download an additional thirty seconds of the media file before and/or after the identified portion.

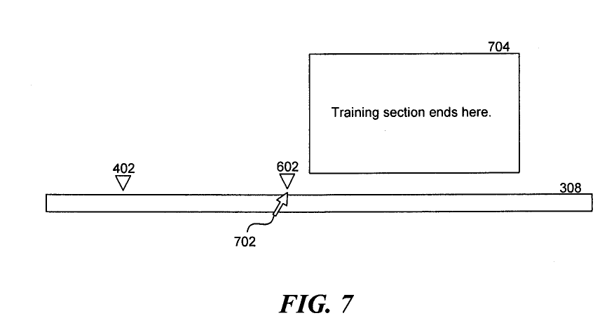

FIG. 7 is a display diagram illustrating rendering of a text annotation. The annotation can be rendered in an annotation region 704 when rendering of the media file reaches a particular point or region with which an annotation is associated. The annotation may appear for a specified period of time, such as a few seconds. Alternatively, the facility can render the annotation when the user positions a mouse pointer 702 on or near the indication or marker 602.

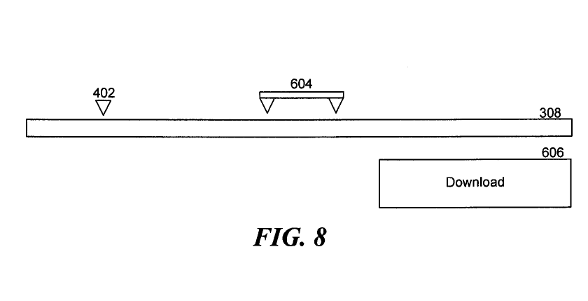

FIG. 8 is a display diagram illustrating a user interface for initiating a download of a media file. A control or command, e.g., a download control 606, enables a user to begin downloading identified portions of the media file. According to the illustration, portions of the media file identified by markers 402 and 604 will be downloaded. In various embodiments, these portions can be downloaded separately or together as a single media file.

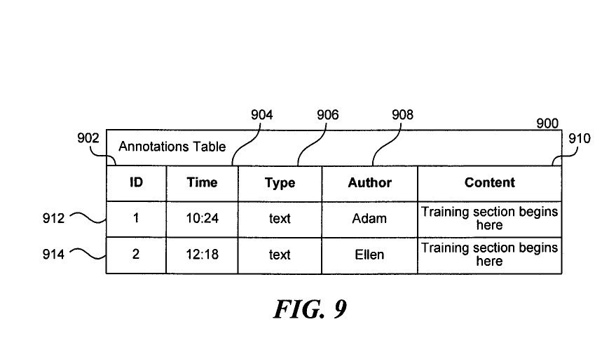

FIG. 9 is a table diagram illustrating an annotations table in various embodiments. The annotations table is associated with a media file and describes the annotations associated with that media file. Adding annotations to a media file is described in the patent application referenced above.

Annotations table 900 has ID 902, time 904, type 906, author 908, and content 910 columns. The ID column identifies each stored annotation. The time column indicates a time or time span, in relation to the beginning of the media file, with which the annotation is to be associated. As an example, annotation 912 is associated with the media file at 10 minutes and 24 seconds after the beginning of the media file. The type column indicates the type of the annotation. Annotations 912 and 914 are text annotations. Other types of annotations include audio, video, image, document change, and so forth. The author column indicates the user who provided the annotation. The content column stores the contents of the annotation. The content column can contain text, an identifier of a file (e.g., uniform resource locator or file path), identification of a position in a document and a change made by the user, and so forth. When the facility searches annotations, it will generally search the author and content columns, but could also search other columns of the annotations table.

While FIG. 9 and its related description shows a table whose contents and organization are designed to make them more comprehensible by a human reader, those skilled in the art will appreciate that actual data structures used by the facility to store this information may differ from the table shown, in that they, for example, may be organized in a different manner, may contain more or less information than shown, may be compressed and/or encrypted, etc.

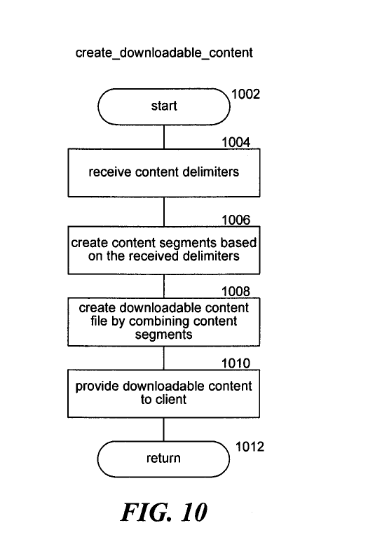

FIG. 10 is a flow diagram illustrating a create_downloadable_content routine invoked by the facility in some embodiments. The facility invokes the routine to create a downloadable media file that contains indicated portions of an original media file. The routine begins at block 1002.

At block 1004, the routine receives one or more sets of content delimiters. Content delimiters indicate the start and end time, relative to the beginning of the media file, for each portion of the media file that is to be downloaded. Content delimiters are identified by markers identified by the user, either manually or by performing a search.

At block 1006, the facility creates content segments based on the received delimiters. In various embodiments, the facility extracts portions of the content file identified by the delimiters and stores them as separate content files. In some embodiments, the facility stores the segments together in a single downloadable content file.

At block 1008, the facility creates a downloadable content file. As an example, when the facility stores separate content files that were extracted from the original content file, the facility may combine them to create a single downloadable content file. In some embodiments, the facility provides the multiple portions as separate downloadable content files.

At block 1010, the facility provides the downloadable content files to the client computer from which it received the request.

At block 1012, the routine returns.

Those skilled in the art will appreciate that the logic illustrated in FIG. 10 and its relating description may be altered in a variety of ways. For example, the order of the logic may be rearranged, logic may be performed in parallel, logic may be omitted or added, etc.

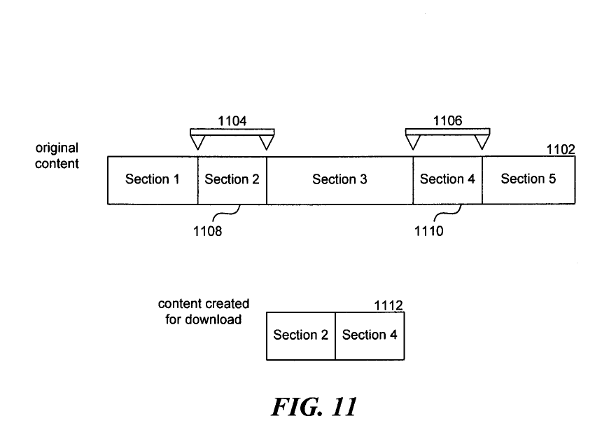

FIG. 11 is a block diagram illustrating an example comparing original content and content that has been prepared for downloading. Markers 1104 and 1106 identify content portions 1108 and 1110 of an original media file 1102 that the facility extracts and combines to create downloadable media file 1112.

In some embodiments, the original media file may be a streaming content file from which portions are extracted for downloading. Alternatively, the original media file may be a downloadable media file that is too large to be downloaded practically. By using the facility, users are able to download portions of media files that are too large or cannot be downloaded. In some embodiments, a user may be able to view a portion of a collaboration during the collaboration session.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

We claim:

1. A computer-readable medium having computer-executable instructions that, when executed, cause a computer system to perform a method for downloading portions of a media file, the method comprising:
displaying a timeline indicating a duration of the media file, the media file located on a host computing device that shares the media file;
receiving a search term from a user;
providing the received search term to the host computing device;
receiving from the host computing device identifications of portions of the media file that correspond to the provided search term;
displaying in an area near the timeline an indication of the identified portions of the media file;
receiving from the user an indication of an identified portion that is to be downloaded; and
downloading the indicated portion of the media file from the host computing device without downloading other portions of the media file.

2. The computer-readable medium of claim 1, further comprising:
receiving an indication to render an annotation associated with the media file; and
rendering the associated annotation.

3. The computer-readable medium of claim 2 wherein the rendering includes displaying a text annotation.

4. The computer-readable medium of claim 1 wherein content in the identified portions of the media file correspond to the provided search term.

5. The computer-readable medium of claim 1 wherein an annotation associated with the media file corresponds to the provided search term.

6. A method performed by a computer system for downloading a portion of a media file, comprising:
displaying a timeline on a first computing device, the timeline indicative of a duration of the media file, the media file stored on a second computing device;
identifying a portion of the media file;
requesting the identified portion of the media file from the second computing device; and
downloading to the first computing device the identified portion of the media file but not the portions of the media file that were not identified.

7. The method of claim 6 wherein the media file is a digitized recording of a collaboration.

8. The method of claim 6 wherein the media file is a multimedia file.

9. The method of claim 6 wherein the identifying includes providing indications on the timeline of a start and an end of the portion of the media file that is to be downloaded.

10. The method of claim 6 wherein the identifying includes searching for information associated with the media file.

11. The method of claim 10 wherein the information associated with the media file includes an annotation.

12. The method of claim 10 wherein the information associated with the media file includes searchable information contained by the media file.

13. The method of claim 10 wherein the searching identifies multiple portions of the media file.

14. The method of claim 13, further comprising identifying one of the multiple portions of the media file for downloading.

15. The method of claim 6 wherein the requesting includes providing an indication of a search term.

16. A system for providing a downloadable media file, comprising:
a content server application that provides an original media file to a client computing system;
an annotations component that stores annotation information associated with the original media file; and
a search component that receives a search term, searches the annotation information to identify portions of the original media file corresponding to the search term, and provides indications of the identified portions so that at least one of the identified portions can be downloaded.

17. The system of claim 16 wherein the search component searches content contained in the original media file to identify portions of the original media file corresponding to the search term.

18. The system of claim 16 wherein the annotation information identifies a start time and an end time for a portion of the original media file corresponding to the search term.

19. The system of claim 16 wherein the indications of the identified portions identify a start time and an end time for each identified portion of the original media file so that the client computing system can identify the portions on a timeline corresponding to the original media file.

20. The system of claim 19 wherein the annotation information contains information that is created during a collaboration session.
